(19) United States
(12) Patent Application Publication
(10) Pub. No.: US 2006/0169126 A1
(43) Pub. Date: Aug. 3, 2006

(54) Music classification device, music classification method, and program

(76) Inventors: Takehiko Ishiwata, Saitama (JP); Yoshimoto Takasawa, Kanagawa (JP); Isoharu Nishiguchi, Kanagawa (JP); Ichiro Tokuhiro, Tokyo (JP)

Correspondence Address: Glenn J Perry;Smith Gambrell & Russell, 1850 M Street N W, Washington, DC, 20036, US

(21) Appl. No.: 10/528,203

(22) PCT Filed: Sep. 17, 2003
(86) PCT No.: PCT/JP03/11823

§ 371 Date: Sep. 28, 2005

(51) Int. Cl. G10H 1/00; G10H 1/18; G10H 7/00

(52) U.S. Cl. 84/615

(57) ABSTRACT

A parameter used in sorting genre is adequately set to improve sorting accuracy. To this end, a music sorter includes a parameter selecting section 160 for obtaining a plurality of candidate genres which are genres to which the music possibly belongs and for selecting a sorting parameter type which is a type of a parameter used for judging the genre to which the music belongs among a plurality of types of parameters which characterize music based on the plurality of candidate genres and a genre judging section 200 for judging either one of the plurality of candidate genres to which the music belongs based on a value of the sorting parameter type of the music.

### FIELD OF THE INVENTION

The present invention relates to a music sorter, a music sorting method and a program for sorting music. More specifically, the invention relates to a music sorter, a music sorting method and a program for automatically and accurately sorting music.

### BACKGROUND ART

Technology for automatically sorting music per genre is being developed.

For instance, there is a technology of storing music software having characteristic parts specified in advance among music software stored in a first recording medium to a second recording medium. (Japanese Patent Laid-Open No. 2000-268541 for example).

There is also a technology for detecting rhythm, tempo, tonality and progress of codes of music to judge music genre based on the detected rhythm, tempo, tonality and progress of codes of the music (Japanese Patent Laid-Open No. 1999-161654 for example).

Still more, there is a technology for automatically sorting music based on fluctuation characteristics such as amplitude fluctuation, frequency fluctuation and event fluctuation (Yasuhiko Tawara and three others “Various Problems in Evaluating Music Environments By Using Fluctuation Characteristics” Collection of Theses of Lectures of the Acoustical Society of Japan, September 1997, p 721-722, and Yasuhiko Tawara and three others, “Analysis of Fluctuation Characteristics of Various Music and Natural Sounds: Study in Parameterizing Regressive Analysis Frequency Range” Collection of Theses of Lectures of the Acoustical Society of Japan, March 1998, p 791-792 for example).

It is necessary to improve sorting accuracy further in order to put a music automatic sorter into practical use. Although there is a plurality of parameters that characterize music, it is difficult to sort music along the human sense unless the parameters used in sorting genre are adequately set.

Accordingly, it is an object of the invention to provide a music sorter, a music sorting method and a program for sorting music which are capable of solving the above-mentioned problem. This object may be achieved through the combination of features described in independent claims of the invention. Dependent claims thereof specify preferable embodiments of the invention.

### SUMMARY OF INVENTION

According to a first aspect of the invention, there is provided a music sorter for sorting music, having a parameter selecting section for obtaining a plurality of candidate genres which are genres to which the music possibly belongs and for selecting a sorting parameter type which is a type of a parameter used for judging the genre to which the music belongs among a plurality of types of parameters which indicate characteristics of music based on the plurality of candidate genres and a genre judging section for judging either one of the plurality of candidate genres to which the music belongs based on a value of the sorting parameter type of the music.

The music sorter described above may further include a sorting parameter type storing section for storing the sorting parameter types in advance per combination of a plurality of genres and the parameter selecting section obtains the sorting parameter type corresponding to the combination of the plurality of candidate genres in the sorting parameter type storing section from the sorting parameter type storing section.

The music sorter may also include a typical value storing section for storing, per genre, a typical value that is a value of the parameter most typical to the genre per plurality of parameters. Then, preferably the genre judging section calculates the value of the sorting parameter type in the music, obtains the typical value of the sorting parameter type of each of the plurality of candidate genres from the typical value storing section and judges the genre to which the music belongs based on a difference between the calculated value of the sorting parameter type and the obtained typical value.

In this case, the music sorter may further include a sorting parameter type storing section for storing, in advance, more than two types of sorting parameter types and a weight coefficient indicating weight among the more than two types of sorting parameter types per combination of a plurality of genres. Then, preferably, the genre judging section calculates each value of more than two types of parameters which are the sorting parameter types per the plurality of genres, weights and averages the differences of the calculated value and the typical value in accordance to the weight coefficient stored in the sorting parameter type storing section and judges the genre to which the music belongs based on the result of the weighted mean.

The music sorter may further include a genre storing section for storing the plurality of genres in hierarchy such that the plurality of genres in the lower hierarchy correspond to each of the plurality of genres in the upper hierarchy. Then, preferably, the parameter selecting section obtains the plurality of genres in the lower hierarchy corresponding to the genre of the upper hierarchy again from the genre storing section after when the genre judging section has judged the genre in the upper hierarchy to select the sorting parameter types based on the plurality of genres in the lower hierarchy and the genre judging section judges again the genre in the lower hierarchy to which the music belongs based the sorting parameter type selected by the parameter selecting section.

The music sorter may further include a typical value storing section for storing a typical value which is a value of the parameter most typical to the genre per the plurality of parameters and the parameter selecting section may obtain the typical value per the plurality of parameter corresponding to each of the plurality of genres obtained by the genre obtaining section from the typical value storing section and selects a parameter whose typical value disperses most among the plurality of genres as the sorting parameter type.

The genre judging section may calculate a value of the sorting parameter type in the music per plurality of frequency bands which are different from each other to sort the music based on the value of the sorting parameter type per plurality of frequency bands.

The music sorter may further include a range storing section for storing, per genre, a range of the parameter that is possibly taken by a music that belongs to the genre per plurality of parameters and the genre judging section may judge the genre to which the music belongs based on the calculated value of the sorting parameter type and the range of the sorting parameter type stored in the range storing section per genre.

According to a second aspect of the invention, there is provided a music sorting method for sorting music wherein a computer obtains a plurality of candidate genres which are genres to which the music possibly belongs, selects a sorting parameter type which is a type of a parameter used for judging a genre to which the music belongs among a plurality of parameter types characterizing the music based on the plurality of candidate genres and judges either one of the plurality of candidate genres to which the music belongs based on a value of the sorting parameter type in the music.

According to a third aspect of the invention, there is provided a program executable by a computer for sorting music that causes the computer to implement functions of obtaining a plurality of candidate genres which are genres to which the music possibly belongs, selecting a sorting parameter type which is a type of a parameter used for judging a genre to which the music belongs among a plurality of types of parameters which characterize music based on the plurality of candidate genres and judging either one of the plurality of candidate genres to which the music belongs based on a value of the sorting parameter type in the music.

It is noted that the summary of the invention described above does not necessarily describe all necessary features of the invention. The invention may also be a sub-combination of the features described above.

### BRIEF DESCRIPTION OF THE DRAWINGS

FIG. 1 is a block diagram showing a configuration of a music sorter 100 according to an embodiment.

FIG. 2 is a chart showing a data structure of a sorting parameter type storing section 120 in a table form.

FIG. 3 is a chart showing a data structure of a typical value storing section 140.

FIG. 4 is a flowchart showing operations of the music sorter 100.

FIG. 5 is a flowchart showing the detail of a music analyzing process (S40) in FIG. 4.

FIG. 6 is a flowchart showing the detail of a sorting process (S60) in FIG. 4.

FIG. 7 is a block diagram showing a structure of a first modification of the music sorter 100.

FIG. 8 is a flowchart showing the detail of the operation (S60 in FIG. 4) of the music sorter 100 of the first modification in sorting genre.

FIG. 9 is a block diagram showing a configuration of a second modification of the music sorter 100.

FIG. 10 is a chart showing a data structure of a range storing section 150.

### DETAILED DESCRIPTION OF THE INVENTION

The invention will now be described based on preferred embodiments, which do not intend to limit the scope of the invention, but exemplify the invention. All of the features and the combinations thereof described in the embodiments are not necessarily essential to the invention.

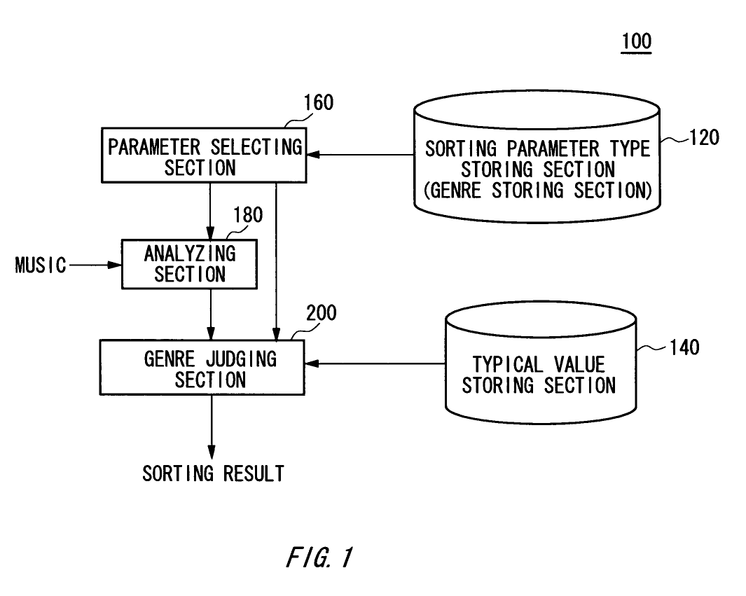

FIG. 1 is a block diagram showing a configuration of a music sorter 100 according to an embodiment. The music sorter 100 sorts inputted music automatically per genre. At this time, the music sorter 100 selects parameter types used in judging genre to which the music belongs based on a plurality of candidate genres of the genre to which the music possibly belongs.

The music sorter 100 is provided with a sorting parameter type storing section 120, a typical value storing section 140, a parameter selecting section 160, an analyzing section 180 and a genre judging section 200. The sorting parameter type storing section 120 functions also as a genre storing section.

The sorting parameter type storing section 120 stores combinations of a plurality of genres and sorting parameter types which are parameters used in discriminating either one of the plurality of genres to which the music belongs while correlating them each other.

The typical value storing section 140 stores typical values which are values of most typical parameters of the genres per genre and per each of the plurality of parameters.

When the music sorter 100 receives music data, the parameter selecting section 160 obtains the plurality of candidate genres to which the obtained music possibly belongs and the sorting parameter types corresponding to the plurality of candidate genres from the sorting parameter type storing section 120 and outputs them to the genre judging section 200. Here, in selecting the plurality of candidate genres, the parameter selecting section 160 uses the sorting result of the genre in the upper hierarchy selected by the genre judging section 200.

The parameter selecting section 160 also outputs the sorting parameter types thus obtained to the analyzing section 180.

The analyzing section 180 receives and analyzes the data of the music to be processed and calculates values of the music per each of the plurality of parameters. Then, it outputs the value of each calculated parameter to the genre judging section 200.

The genre judging section 200 receives a typical value of the sorting parameter type corresponding to each of the plurality of candidate genres obtained from the parameter selecting section 160 from the typical value storing section 140. Then, the genre judging section 200 judges the genre to which the music belongs based on the typical value of the sorting parameter type and the value of the sorting parameter type obtained from the analyzing section 180 and outputs the judged result to the outside. When the genre judging section 200 judges the genre in the upper hierarchy here, it outputs the judged result to the parameter selecting section 160.

That is, the music sorter 100 selects the types of parameters used in the judgement based on the plurality of candidate genres to which the music possibly belongs. Accordingly, it can judge the genre of the music accurately and sort the music. Still more, because it is capable of narrowing down a number of the parameters used in the judgement, it can lessen the burden applied to it.

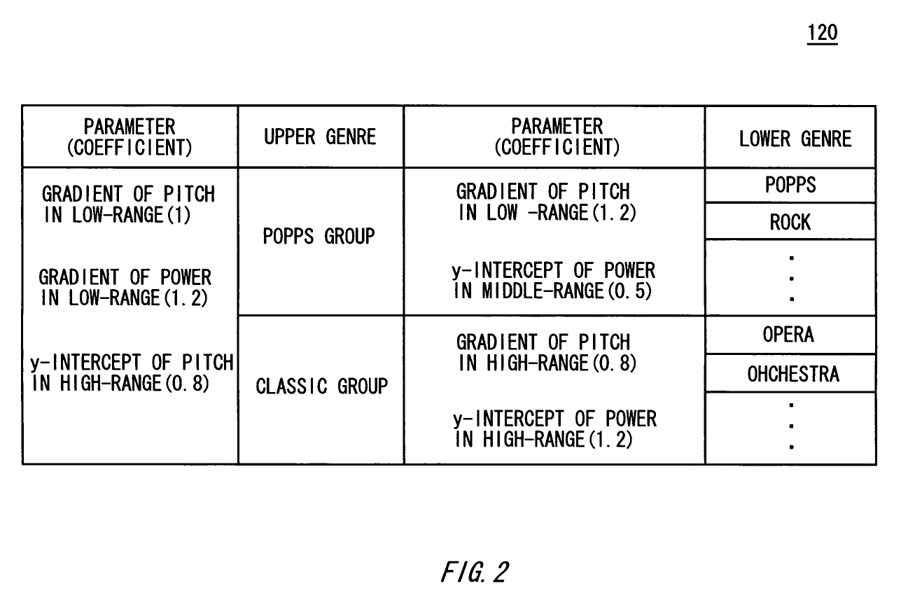

FIG. 2 is a chart showing a data structure of the sorting parameter type storing section 120 in a table format.

The sorting parameter type storing section 120 stores the plurality of sorting parameter types per each of the plurality of candidate genres and weight coefficients indicating weight of the respective sorting parameter types. That is, the genre judging section 200 of the music sorter 100 carries out an adding process on the values of the sorting parameter types calculated by the analyzing section 180 in accordance to the weight coefficients and sorts the music based on the result of adding process.

Accordingly, the music sorter 100 can judge the genre of the music more accurately by setting the weight coefficient at an adequate value. Still more, the music sorter 100 can always sort the music to either one of the genres.

The sorting parameter type storing section 120 also sorts the plurality of candidate genres in hierarchy. That is, it stores the plurality of the candidate genres such that the candidate genres in the lower hierarchy correspond to each of the plurality of the candidate genres in the upper hierarchy.

That is, after selecting one candidate genre belonging to the upper hierarchy to which the music belongs, the music sorter 100 judges either one of the candidate genre in the lower hierarchy to which the music belongs among the plurality of candidate genres in the lower hierarchy corresponding to the genre in the upper hierarchy.

Accordingly, the music sorter 100 can judge the genre of the music accurately even if there are many candidate genres.

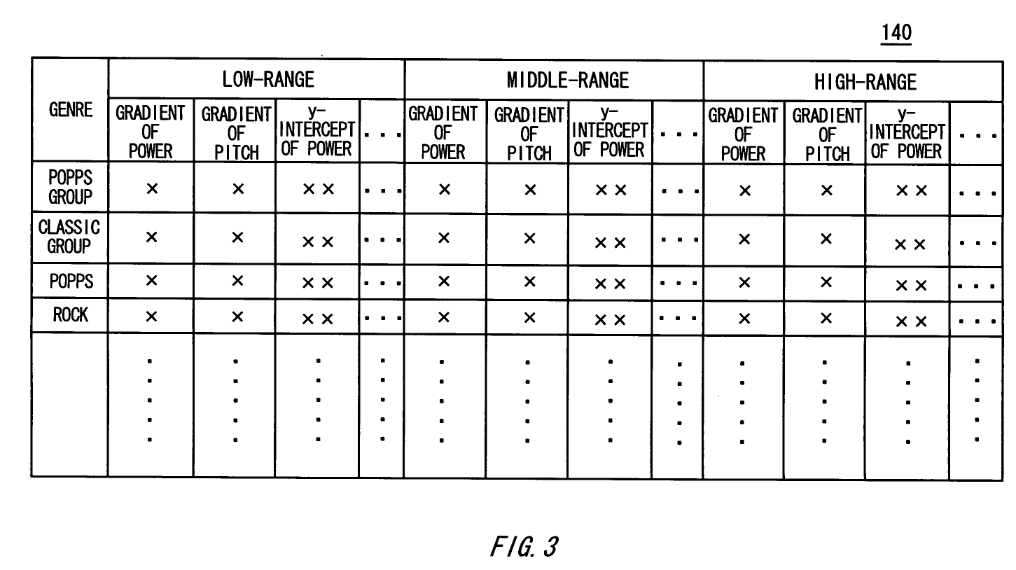

FIG. 3 is a chart showing a data structure of the typical value storing section 140 in a table format. The typical value storing section 140 stores typical values of the respective parameters per genre. Here, the typical value storing section 140 stores the typical values of the respective parameters of the same type per each of plurality of frequency bands, e.g., per three ranges of low, middle and high ranges. The frequency of the low-range is less than 200 Hz for example, that of the middle-range is 200 to 600 Hz for example and that of the high-range is more than 600 Hz for example.

Depending on the genre, its characteristics may become clear by providing the values of the parameters separately per frequency band. Accordingly, the music sorter 100 can sort music more accurately.

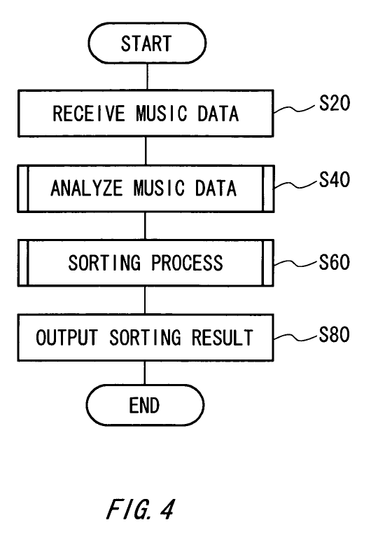

FIG. 4 is a flowchart showing the operations of the music sorter 100. By receiving music data (S20), the analyzing section 180 analyzes the music data and calculates parameter values of the music (S40). Then, based on the calculated parameter values and the typical values corresponding to the plurality of candidate genres, the genre judging section 200 executes the sorting process (S60). Then, the genre judging section 200 outputs the judged sorting result to the outside (S80).

Accordingly, the music sorter 100 can judge the genre of the music data when it receives the music data.

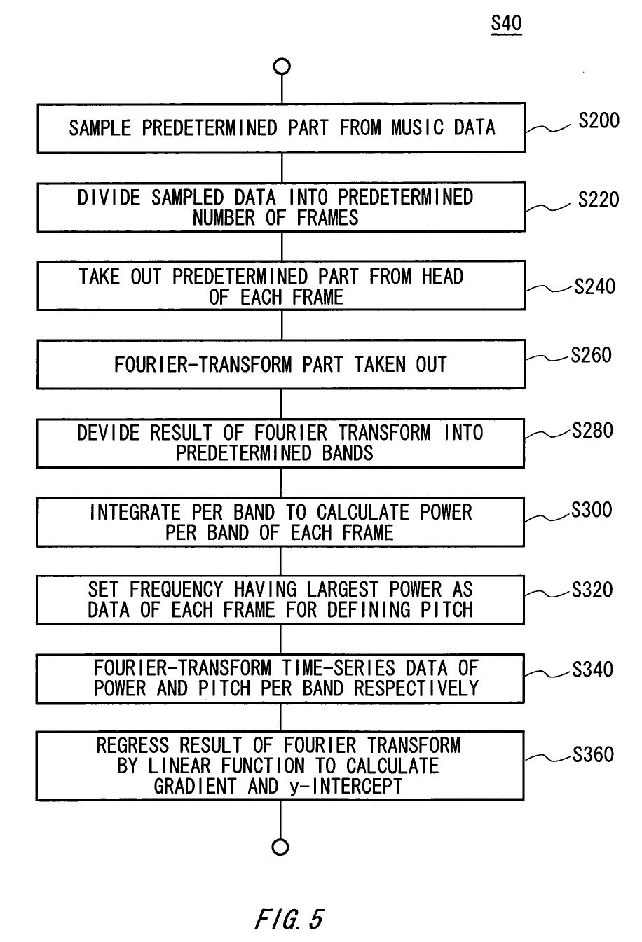

FIG. 5 is a flowchart showing the detail of the music analyzing process (S40) in FIG. 4.

The analyzing section 180 samples a predetermined part from the received music data (S200). The predetermined part is a time of 100 seconds from the start of analysis such as a starting point of the music. Then, the analyzing section 180 equally divides the sampled data into a predetermined number of frames (S220). The predetermined number is 2,048 for example. Then, it takes out the predetermined part from the head of each frame (S240). The predetermined part here is the point of 1024 from the head for example which corresponds to about 46 milliseconds in the data format normally used in CDs, i.e., in a stereo format of sampling of 44.1 kHz and quantization of 16 bits.

Then, the analyzing section 180 Fourier-transforms the part taken out in S240 (S240) and divides the result of the Fourier transform into the predetermined frequency bands, e.g., the low, middle and high ranges in FIG. 3 (S280). The Fourier transform is fast Fourier/sine/cosine transform (FFT) for example.

After that, the analyzing section 180 calculates power per band of each frame by integrating per frequency band (S300) and sets the frequency band having the largest power as data of each frame for defining a pitch (S320). When the data for defining the power and the pitch are lined up in order of the frames, they turn out to be time-series data of the power and time-series data for defining the pitch. It is noted that the power per band calculated in S300 is one of the parameters.

Then, the analyzing section 180 Fourier-transforms the time-series data of the power and the time-series data for defining the pitch per frequency band, respectively (S340).

Then, treating the result of the Fourier transform as a plurality of (x, y) data wherein a variable is an inverse number of the frequency, the analyzing section 180 finds a regression curve to the plurality of (x, y) data by means of least square. Then, the analyzing section 180 recognizes a gradient and a y-intercept of the regression curve per frequency band as parameters (S360).

That is, the analyzing section 180 obtains the power and the gradient and y-intercept of the regression curve as the parameters per plurality of frequency bands. Therefore, it can calculate the plurality of types of parameters.

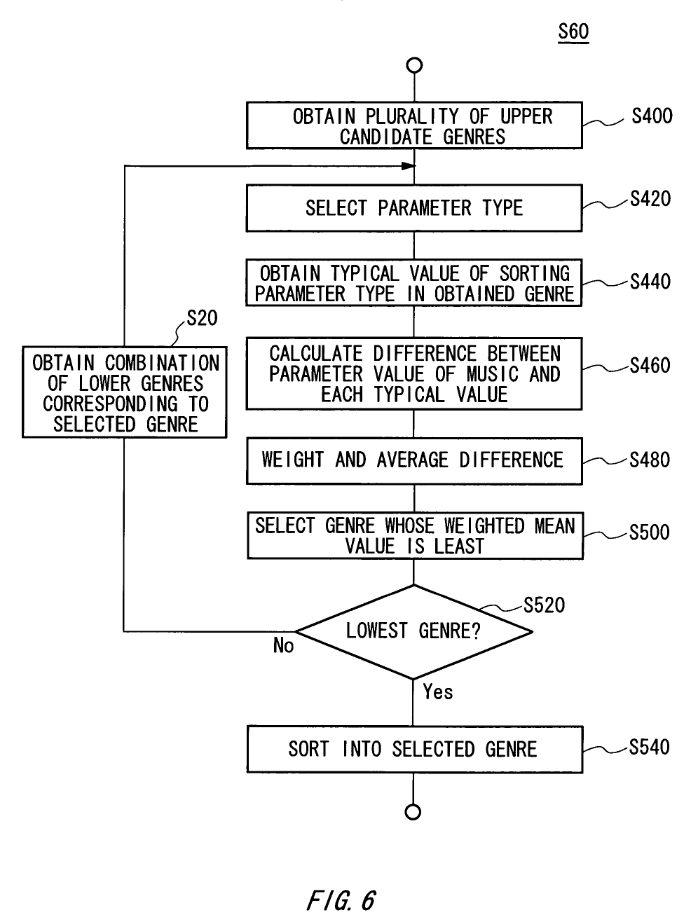

FIG. 6 is a flowchart showing the detail of the sorting process (S60) in FIG. 4. At first, the genre judging section 200 obtains the plurality of candidate genres in the upper hierarchy from the sorting parameter type storing section 120 via the parameter selecting section 160 (S400) and selects the sorting parameter type by obtaining the types of parameters corresponding to the plurality of obtained candidate genres in the upper hierarchy from the sorting parameter type storing section 120 (S420). Then, it obtains the typical values of the sorting parameter types in the plurality of candidate genres in the upper hierarchy (S440).

Then, the genre judging section 200 calculates a difference between the obtained typical value and the value calculated in S40 per genre and per parameter (S460) and weights and averages the calculated difference in accordance to the weight coefficient stored in the sorting parameter type storing section 120 (S480). It then selects the genre whose weighted mean value is least (S500). When the selected genre belongs to the lowest hierarchy, the genre judging section 200 sorts the music into the selected genre (S540). When there is a still lower hierarchy, the genre judging section 200 obtains a plurality of lower genres corresponding to the selected genre (S560) and returns to S420.

Accordingly, the music sorter 100 can judge the genre to which the music belongs based on the difference from the typical value.

It is noted that in FIG. 6, the genre judging section 200 may weight and average a square of the difference in accordance to the weight coefficient and may sort the music into the genre wherein the average value is least. Still more, it may sort the music into the genre wherein a sum of the differences is least.

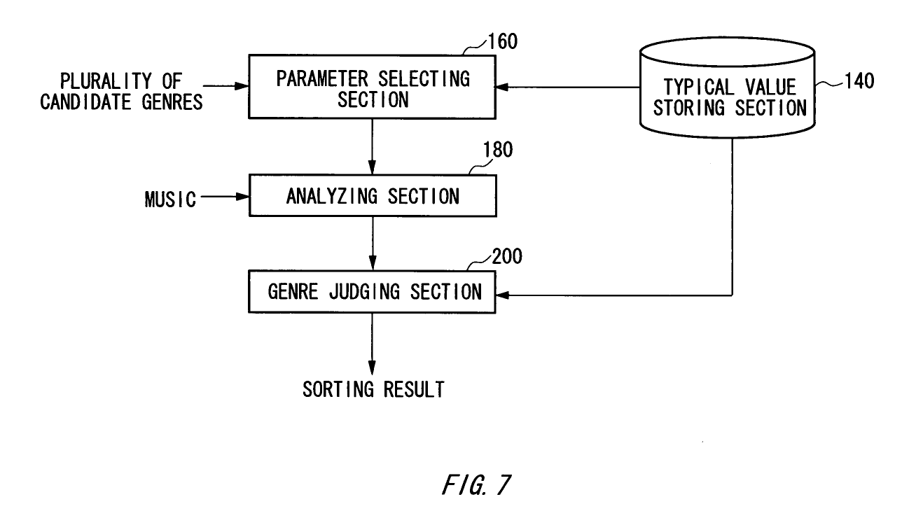

FIG. 7 is a block diagram showing a structure of a first modification of the music sorter 100. The music sorter 100 of this case is different from the music sorter 100 in FIG. 1 in that it does not have the sorting parameter type storing section 120 and that the parameter selecting section 160 determines the sorting parameter type based on the plurality of candidate genres and information stored in the typical value storing section 140.

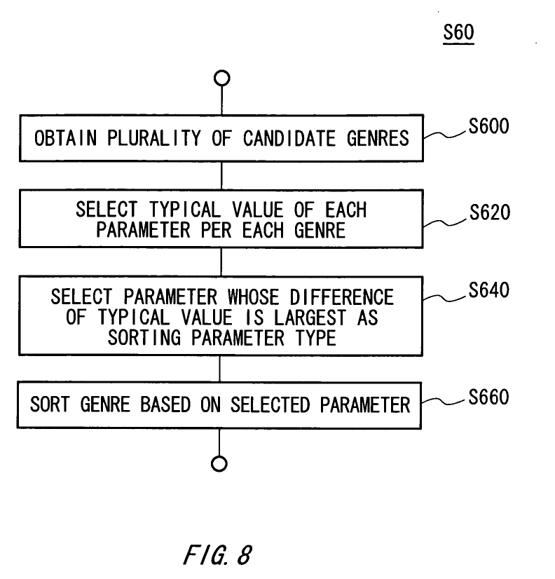

FIG. 8 is a flowchart showing the detail of the operation (S60 in FIG. 4) of the music sorter 100 of the first modification in sorting genre. When the parameter selecting section 160 obtains a plurality of candidate genres at first (S600), it obtains a typical value of each parameter from the typical value storing section 140 per plurality of candidate genres (S620). Then, it selects a parameter whose typical value disperses most among the plurality of candidate genres (S640). Then, the music sorter 100 sorts the music into the genre wherein the value of the parameter type of the music to be sorted is closest to the typical value (S660).

That is, according to this modification, the music sorter 100 selects the type of the parameter whose typical value disperses most among the plurality of candidate genres as the sorting parameter type. Accordingly, it can sort the music accurately.

It is noted that the plurality of candidate genres may be inputted from the outside or may be stored in database in advance in this modification.

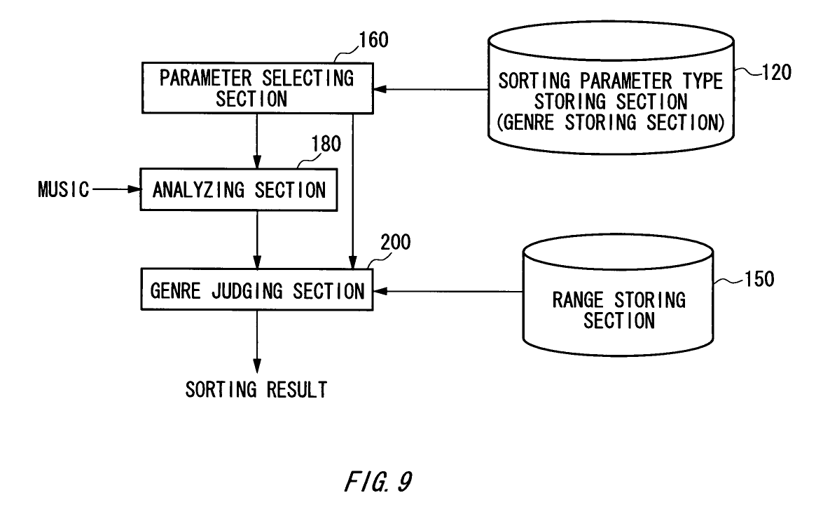

FIG. 9 is a block diagram showing a configuration of a second modification of the music sorter 100. The music sorter 100 of this modification is the same with the music sorter 100 shown in FIG. 1 except of that it has a range storing section 150 instead of the typical value storing section 140. That is, the genre judging section 200 sorts the music based on the parameter value of the analyzed music and data stored in the range storing section 150.

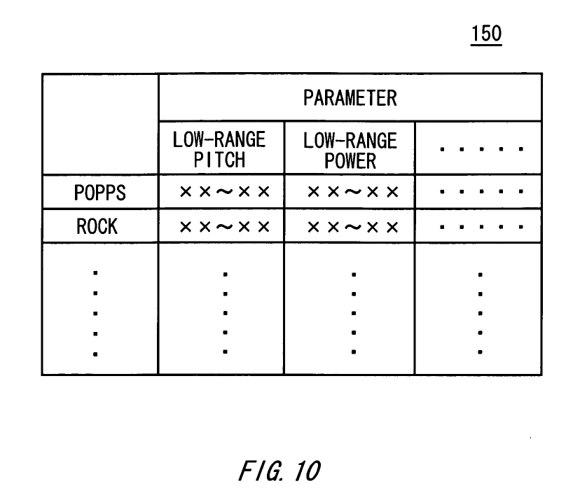

FIG. 10 is a chart showing a data structure of the range storing section 150 in a table form. The range storing section 150 stores a range of parameters to be taken by the music that belongs to a genre per genre and per parameter.

That is, the genre judging section 200 judges the range of the genre in which the parameter value calculated by the analyzing section 180 is contained and sorts the music in accordance to the result of this judgment. At this time, the plurality of candidate genres and the sorting parameter type to be used conform to data stored in the sorting parameter type storing section 120.

Accordingly, the music sorter 100 of the second modification can sort the music accurately by adequately setting the range of parameters per genre in advance.

It is noted that the genre judging section 200 may select the parameter whose range stored in the range storing section 150 disperses most in the plurality of candidate genres as the sorting parameter type when this modification is configured so as to obtain the plurality of candidate genres from the outside.

Still more, this modification may also have the typical value storing section 140. In this case, the music sorter 100 can sort the music by carrying out the process shown in FIG. 6 to the music whose value of sorting parameter type does not fall into any genre.

It is noted that the music sorter 100 may be realized by installing a predetermined program to a computer via a removable media for example. The program may be also downloaded to the computer via a communication network.

Although the invention has been described by way of the exemplary embodiments, it should be understood that those skilled in the art might make many changes and substitutions without departing from the spirit and scope of the invention. It is obvious from the definition of the appended claims that the embodiments with such modifications also belong to the scope of the invention.

### INDUSTRIAL APPLICABILITY

As it is apparent from the above explanation, the invention allows music to be sorted accurately.

What is claimed is:

1. A music sorter for sorting music, comprising:
a parameter selecting section for obtaining a plurality of candidate genres which are genres to which said music possibly belongs and for selecting a sorting parameter type which is a type of a parameter used for judging the genre to which said music belongs among a plurality of types of parameters which indicate characteristics of music based on said plurality of candidate genres; and
a genre judging section for judging either one of said plurality of candidate genres to which said music belongs based on a value of said sorting parameter type of said music.

2. The music sorter as set forth in claim 1, further comprising a sorting parameter type storing section for storing said sorting parameter types in advance per combination of a plurality of genres; wherein
said parameter selecting section obtains said sorting parameter type corresponding to the combination of said plurality of candidate genres in said sorting parameter type storing section from said sorting parameter type storing section.

3. The music sorter as set forth in claim 1, further comprising a typical value storing section for storing, per genre, a typical value which is a value of said parameter most typical to the genre per said plurality of parameters; wherein
said genre judging section calculates the value of said sorting parameter type in said music;
obtains the typical value of said sorting parameter type of each of said plurality of candidate genres from said typical value storing section; and
judges the genre to which said music belongs based on a difference between the calculated value of said sorting parameter type and said obtained typical value.

4. The music sorter as set forth in claim 3, further comprising a sorting parameter type storing section for storing more than two types of said sorting parameter types and a weight coefficient indicating weight among said more than two types of sorting parameter types per combination of a plurality of genres; wherein
said genre judging section calculates each value of more than two types of parameters which are said sorting parameter types per said plurality of genres, weights and averages the differences of the calculated value and said typical value in accordance to the weight coefficient stored in the sorting parameter type storing section and judges the genre to which said music belongs based on the result of the weighted mean.

5. The music sorter as set forth in claim 1, further comprising a genre storing section for storing said plurality of genres in hierarchy so that said plurality of genres in the lower hierarchy correspond to each of said plurality of genres in the upper hierarchy; wherein
said parameter selecting section obtains said plurality of genres in the lower hierarchy corresponding to the genre in the upper hierarchy again from said genre storing section after when said genre judging section has judged said genre in the upper hierarchy to select said sorting parameter type based on said plurality of genres in the lower hierarchy; and
said genre judging section judges again the genre in the lower hierarchy to which said music belongs based on said sorting parameter type selected by said parameter selecting section.

6. The music sorter as set forth in claim 1, further comprising a typical value storing section for storing a typical value which is a value of said parameter most typical to the genre per said plurality of parameters; wherein
said parameter selecting section obtains the typical value per said plurality of parameter corresponding to each of said plurality of genres obtained by said genre obtaining section from said typical value storing section and selects a parameter whose typical value disperses most among said plurality of genres as said sorting parameter type.

7. The music sorter as set forth in claim 1, wherein said genre judging section calculates a value of said sorting parameter type in said music per plurality of frequency bands which are different from each other and sorts said music based on the value of said sorting parameter type per plurality of said frequency bands.

8. The music sorter as set forth in claim 1, further comprising a range storing section for storing, per said genre, a range of said parameter that is possibly taken by a music that belongs to the genre per plurality of said parameters; wherein
said genre judging section judges the genre to which said music belongs based on the calculated value of said sorting parameter type and the range of said sorting parameter type stored in said range storing section per genre.

9. A music sorting method for sorting music, wherein a computer obtains a plurality of candidate genres to which said music possibly belongs, selects a sorting parameter type which is a type of a parameter used for judging a genre to which said music belongs among a plurality of types of parameters which characterize music based on said plurality of candidate genres and judges either one of said plurality of candidate genres to which said music belongs based on a value of said sorting parameter type in said music.

10. A program executable by a computer for sorting music that causes said computer to implement functions of:
obtaining a plurality of candidate genres to which said music possibly belongs and selecting a sorting parameter type which is a type of a parameter used for judging a genre to which said music belongs among a plurality of types of parameters which characterize music based on said plurality of candidate genres; and
judging either one of said plurality of candidate genres to which said music belongs based on a value of said sorting parameter type in said music.
